(19) United States
(12) Patent Application Publication
(10) Pub. No.: US 2006/0003609 A1
(43) Pub. Date: Jan. 5, 2006

(54) Fastening structure for memory card

(76) Inventor: Tien-Wan Hwang, Jhonghe City (TW)

Correspondence Address: Tien-Wang HWANG, P.O. Box No. 6-57, Junghe, Taipei, 235, TW

(21) Appl. No.: 10/671,799

(22) Filed: Sep. 29, 2003

(51) Int. Cl. H01R 12/00

(52) U.S. Cl. 439/76.1

(57) ABSTRACT

A fastening structure for memory card includes two corresponding upper and lower housings. The upper and lower housing have joined inner stopping walls and outer covering walls, respectively. The fastening structure is applied for assembling and securing the upper and lower housings; and has fastening slots provided at the outer covering walls in a penetrated manner, and fastening tenons formed at outer sides of the inner stopping walls and at positions corresponding to those of the fastening slots. Through the joining method using the fastening slots and the fastening tenons according to the invention, the upper and lower housings are assembled and secured.

### BACKGROUND OF THE INVENTION

(a) Field of the Invention

The invention relates to a fastening structure for memory cards, and more particularly, to a fastening structure that accomplishes requirements as having secure, fast and simple assembly for upper and lower housings of a memory card.

(b) Description of the Prior Art

A common memory card, especially a flash memory card such as secure digital, memory stick, multimedia card, compact flash, and smart media, is a flat-shaped plastic housing body disposed with circuit boards and circuit elements.

In general, present joining means for housing bodies of memory cards are classified into two categories:
1. upper-lower adhesion; upper and lower housings are applied with adhesive to form a housing body; and
2. ultrasonic merging method; a configured lower housing is placed facing upward, an upper housing to be processed by ultrasonic is placed facing downward, and the lower and upper housings are mounted and merged into a housing using ultrasonic process.

However, the aforesaid joining means for memory card housings are performed by adhesion machines or ultrasonic machines. Not only equipment costs are increased, but operating time of these machines are rather lengthy, and hence production speed cannot be elevated.

In addition, the adhesion means having no other fastening devices is prone to loosening due to degradation of adhesive properties of adhesive used or wear caused by long-term use, and is hardly considered as a satisfactory fastening means with respect to assembly of memory cards.

### SUMMARY OF THE INVENTION

The primary object of the invention is to provide a fastening structure for memory cards, so as to securely join upper and lower housings of a memory card with a simple assembly process of wedging.

The other object of the invention is to provide a fastening structure for memory cards, so as to enable upper and lower housings of a memory card to be repeatedly assembled and dissembled without causing damages of the upper and lower housings.

The fastening structure for memory cards according to the invention comprises two corresponding upper and lower housings provided with a fastening structure. The upper and lower housings are assembled into a convenient and secure structure by physical means without requiring equipments such as the conventional adhesion machines and ultrasonic merging machines.

### BRIEF DESCRIPTION OF THE DRAWINGS

FIG. 1 shows an exploded elevational view according to the invention.

FIG. 2 shows a sectional view of the upper housing according to the invention.

FIG. 3 shows a sectional view of the lower housing according to the invention.

FIG. 4 shows a first diagram illustrating an assembly step of the upper and lower housings according to the invention.

FIG. 5 shows a second diagram illustrating an assembly step of the upper and lower housings according to the invention.

FIG. 6 shows a third diagram illustrating an assembly step of the upper and lower housings according to the invention.

### DETAILED DESCRIPTION OF THE PREFERRED EMBODIMENTS

To better understand the technical contents of the invention, detailed descriptions shall be given with the accompanying drawings below.

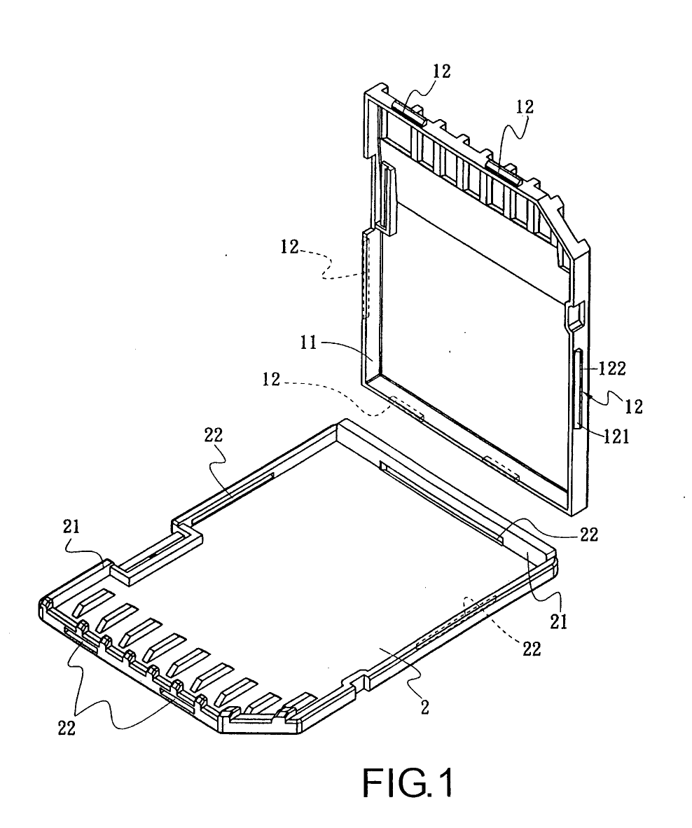

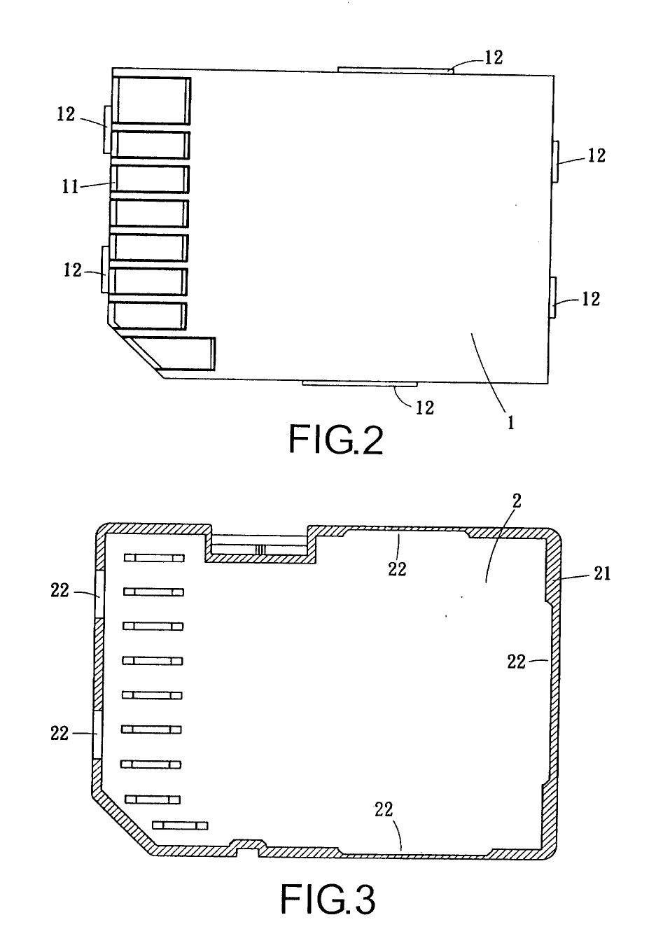

Referring to FIGS. 1 to 3, the memory card according to the invention comprises two corresponding upper and lower housings 1 and 2, which are joined by the fastening structure according to the invention. The fastening structure has fastening tenons 12 and fastening slots 22.

The lower housing 2 has outer covering walls 21 at a periphery thereof. The upper housing 1 has inner stopping walls 22 at a periphery thereof. When the upper and lower housings 1 and 2 are correspondingly combined, the inner stopping walls 11 are joined at inner sides of the outer covering walls 21. The aforesaid tenons 12 are disposed at the inner stopping walls 11 at the periphery of the upper housing 1. Each tenon 12 has an inclined plane 121 at a lower surface thereof, and a prop plane 122 at an upper portion thereof. The fastening slots 22 are correspondingly disposed at the outer covering walls 21 at the periphery of the lower housing 2. Using the aforesaid fastening structure, when joining the upper and lower housings 1 and 2, the upper and lower housings 1 and 2 are assembled and secured using a physical method of wedging the fastening tenons 12 into the fastening slots 22.

In addition, the fastening tenons 12 and the fastening slots 22 may also be arranged at different positions according to various requirements. In other words, the fastening tenons 12 may be disposed at the outer covering walls 21 at the lower housing 2, but at inner sides of the outer covering walls 21. Thus, the fastening tenons 12 are corresponded with the fastening slots 22 at the inner stopping walls 11 of the upper housing 1, thereby accomplishing wedging and securing requirements.

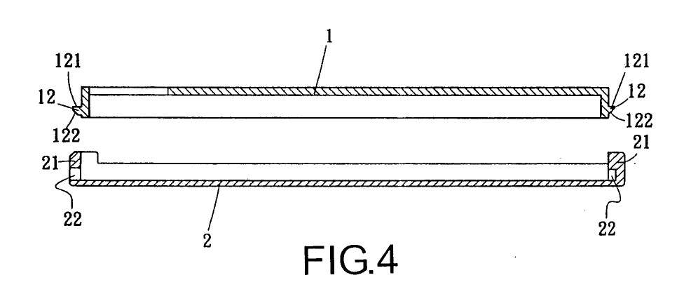

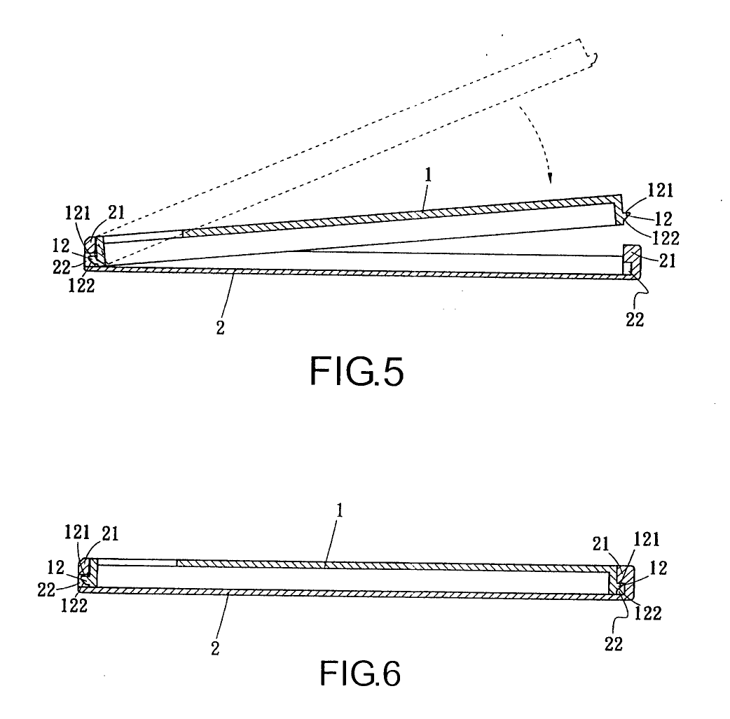

Referring to FIGS. 4, 5 and 6 showing assembly steps of the upper and lower housings 1 and 2 according to the invention, to assemble the upper and lower housings 1 and 2, the fastening tenons 12 at the inner stopping walls 11 at one side of the upper housing 1 are wedged into the fastening slots 22 at the outer covering walls 21 of the lower housing 2. The upper housing 1 is pressed downward to come into contact with the lower housing 2. The fastening tenons 12 at other positions of the upper housing 1 first come into contact with the outer covering walls 21, and are then passed through the upper portions of the outer covering walls 21 via the inclined planes 121 of the fastening tenons 12 to enter the fastening slots 22. At this point, all the prop planes 122 at the upper surfaces of the fastening tenons 12 are in contact with the inner sides of the fastening slots 121 in a retaining state, thereby assembling and securing the upper and lower housings 1 and 2 using structural fastening means. Furthermore, by using the aforesaid structure, when the memory card is damaged, the upper and lower housings 1 and 2 can be repeatedly disassembled to repair internal circuits therein. Therefore, unlike the conventional adhesion or ultrasonic merging means, by which the upper and lower housings 1 and 2 joined are liable to changes to a certain degree and cannot be reused when dissembled, the fastening structure according to the invention can be repeated assembled and dissembled to conform to modern environmental friendly requirements.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A fastening structure for a memory card having two corresponding upper and lower housings, to which the fastening structure is applied, comprising characteristics that, the fastening structure is disposed at peripheries of the upper and lower housings, and has corresponding fastening tenons and fastening slots, thereby assembling and securing the upper and lower housings by means of wedging.

2. The fastening structure for memory cards in accordance with claim 1, wherein the fastening tenons are disposed at the periphery of the upper housing, and the fastening slots are disposed at the periphery of the lower housing.

3. The fastening structure for memory cards in accordance with claim 1, wherein the fastening tenons are disposed at the periphery of the lower housing, and the fastening slots are disposed at the periphery of the upper housing.

4. The fastening structure for memory cards in accordance with claim 1, wherein the lower housing has vertical outer covering walls at the periphery thereof, and the upper housing has inner stopping walls at the periphery thereof, wherein the inner stopping walls are joined at inner sides of the outer covering walls.

5. The fastening structure for memory cards in accordance with claim 4, wherein the outer covering walls are provided with fastening slots, and the inner stopping walls are formed with corresponding fastening tenons.

6. The fastening structure for memory cards in accordance with claim 5, wherein each fastening tenon has an inclined plane at a lower surface thereof and a prop plane at an upper portion thereof.

7. The fastening structure for memory cards in accordance with claim 4, wherein the outer covering walls are provided with fastening tenons, and the inner stopping walls are formed with corresponding fastening slots.

8. The fastening structure for memory cards in accordance with claim 7, wherein each fastening tenon has an inclined plane at a lower surface thereof and a prop plane at an upper portion thereof.

9. A fastening structure for memory cards, and especially a fastening structure for joining upper and lower housings of a memory card, comprising:
outer covering walls formed at a periphery of a lower housing;
inner stopping walls formed at a periphery of an upper housing, and joined at inner sides of the outer covering walls;
fastening slots disposed at the outer covering walls in a penetrated manner; and
fastening tenons formed at outer sides of the inner stopping walls in a projecting manner, and having positions corresponding to those of the fastening slots.

10. The fastening structure for memory cards in accordance with claim 9, wherein each fastening tenon has an inclined plane at a lower surface thereof and a prop plane at an upper portion thereof.
